(19) United States
(12) Patent Application Publication
(10) Pub. No.: US 2026/0148628 A1
(43) Pub. Date: May 28, 2026

(54) PREVENTIVE WATER SUBMERSION DETECTION SYSTEM AND METHOD

(71) Applicant: Safewater Kids, Inc., River Edge, NJ (US)

(72) Inventors: Christine Grace Alvarez, River Edge, NJ (US); Robert D. Karpinos, Woodcliff Lake, NJ (US)

(21) Appl. No.: 19/397,372

(22) Filed: Nov. 21, 2025

Related U.S. Application Data
(60) Provisional application No. 63/723,742, filed on Nov. 22, 2024.

(51) Int. Cl. G08B 21/08; G08B 25/10

(52) U.S. Cl. CPC G08B 21/088; G08B 25/10

(57) ABSTRACT

A preventive water submersion detection system includes wearables, a host device, guest devices, and an application server. The wearables are provided with machine-readable identifiers MIDs and submersion sensors. The host device scans or otherwise pairs with the MIDs and transmits a UID of the host device and the scanned wearable MIDs to the application server. The application server retrieves the UIDs of the wearables to associate each wearable with the host device and one or more guest devices. The application server to establish communication between the host device, the wearables and associated submersion sensors, and the guest devices. Upon detecting an alert condition, based on information received from a submersion sensor of a wearable or a loss of signal between the wearable and host device, guest device, or application server, the application server transmits an alert notification to the host device and the guest device associated with the wearable.

### TECHNICAL FIELD

The present disclosure relates generally to a system and method for water submersion detection and, more particularly, to a preventive water submersion detection system and method, having wearables with unique identifier (UID) codes and integrated submersion sensors designed to enhance personal safety and provide real-time alerts during potential water submersion or other water submersion incidents.

### BACKGROUND

Water submersion is one of the most common causes of accidental death in young children. Water submersion is the number 1 cause of death of children between the ages on 1 and 4, and the second leading cause of unintentional injury deaths for children from five to fourteen years of age. There are four thousand unintentional water submersions every year, which is eleven deaths a day per the Centers for Disease Control and Prevention (CDC). Often, children swim under the supervision of parents or other adults, but it is not unusual for such parents or other adults to be distracted by other things, such as conversations with others. Additionally, children may unexpectedly gain access to an area having a pool without the adult being aware. Furthermore, even if present, such monitoring adults may be unaware of the actual signs a child has become submerged.

Despite this elevated risk, there are few, if any, devices that have been provided to detect a drowning or other water submersion event in an individual and provide a warning to others. Conventional systems and devices for preventing water submersion may include pool alarm systems or underwater surveillance systems.

Conventional systems and devices include limitations and challenges. In addition to technical, installation complexity, and cost considerations, the conventional systems and devices may sometimes trigger false alarms due to non-threatening activities like a large object falling into the pool or heavy rain. Such systems may therefore lead to alarm fatigue, where users become desensitized to the alerts causing a risk of a monitoring user ignoring alarms during dangerous submersion events.

In light of the foregoing, there exists a need to provide a technical solution to overcome the problems of conventional, unintentional water submersion and water submersion detection systems.

### SUMMARY

According to an aspect of the present disclosure, a preventive water submersion detection system includes wearables, a host device, guest devices, and an application server. The wearables are each provided with a machine-readable identifier (MID) and includes submersion sensors. Each MID is associated with a unique identification number (UID) assigned to a wearable. The MIDs are utilized for identification of the wearables, to associate the wearables with other devices, and for communication purposes. The host device includes a MID scanner configured to scan the MIDs provided on the wearables. The host device is configured to transmit a UID of the host device and the scanned or paired MIDs to the application server. The guest devices include a MID scanner configured to scan MIDs embedded on the wearables, and can also be configured to receive a UID of a wearable which has been scanned by another device. The guest devices are configured to transmit UIDs of the guest devices and the scanned MIDs to the application server. The application server is configured to retrieve the UIDs of the wearables from the scanned or paired MIDs of the host device and guest devices. The application server is configured to associate the UID of the host device and the UIDs of the guest devices with the UIDs of the wearables. The application server is configured to establish communication between the host device and the wearable device transceiver, which is in electrical communication with the submersion sensor. The application server is configured to establish communication between the guest devices and submersion sensors via the host device and a communication network. The host device is configured to receive detection information from the submersion sensors and the application server is configured to receive the detection information from the host device and/or guest devices. Based on the association of the UIDs, the application server is configured to transmit alert notifications to the host device and the guest devices associated with a particular wearable indicating an alert condition, such as detection information indicative of a potential submersion or drowning event.

According to another aspect of the present disclosure, the application server is configured to establish communication between the host device and the submersion sensors via the communication network. The application server is configured to establish communication between the guest devices and submersion sensors via the communication network. The application server is configured to receive the detection information from the submersion sensors via the communication network.

According to yet another aspect of the present disclosure, the preventive water submersion detection system includes at least one signal relay. The signal relay is configured to provide a low-power, e.g., short range, connection to the wearable devices and transmit the detection information (or lost-connection detection) received from the submersion sensors directly to the host device and/or guest devices. The application server is configured to establish communication between the host device and the submersion sensors via the signal relay. The application server is configured to establish communication between the guest devices and submersion sensors via the signal relay, the host device, and the communication network. The host device is configured to receive the detection information from the submersion sensors via the signal relay and the application server is configured to receive the detection information from the host device via the communication network.

According to yet another aspect of the present disclosure, in some implementations the signal relay may communicate with the application server directly if the application server is provided outside the host device or the host device is outside of communication range of the signal relay. In some examples, the application server is configured to establish communication between the host device and the submersion sensors via the signal relay and the communication network. The application server is configured to establish communication between the guest devices and submersion sensors via the signal relay and the communication network. The application server is configured to receive the detection information from the submersion sensors via the signal relay and the communication network.

The preventive water submersion detection system facilitates numerous advantages, including early detection of submersion, enhancing child safety by embedding sensors in everyday items like garments, jewelry, or accessories. A user-friendly MID, such as a QR code or near-field communication (NFC) device, and mobile alert app ensure quick setup and ease of use, while allowing multiple receiving units such as mobile phones to receive alerts, providing a robust safety net. The disclosed system offers peace of mind to parents and caregivers, is versatile and adaptable, and leverages modern technology for practical application. It promotes community safety by enabling shared responsibility and customizable alerts, serving as both a preventive measure and a life-saving tool in water hazard environments.

In some aspects of the present disclosure, a wearable device containing a water submersion detector or sensor device may be worn by a user, such as a child or at-risk adult. A monitoring user, such as a parent or guardian, may use a host device or guest device to scan or pair respective devices with the sensor device of the wearable. The machine-readable identifier (MID) of the sensor device of the wearable enables pairing or establishing of a communication link between respective devices and the sensor device associated with the MID. The MID (e.g., a QR code, barcode, NFC device, RFID tag, and the like) contains information related to a universal identifier (UID) of the sensor device of the wearable. Upon reading of the MID, an application server located locally or remotely associates the respective host or guest device UID with the wearable UID. In some examples, if a relay device (e.g., Apple Home device, Alexa-enabled device, Matter-enabled device, and the like) is provided, the relay device may be configured to relay the wearable's sensor device signal and/or connection information to the host device, guest device, locally- (e.g., provided in the host or guest device) or remotely-located (e.g., cloud-based) application server. The application server associates the UIDs of the host device, guest device, and the sensor device of the wearable to thereby establish a communication link. In some examples, this may be a pairing operation and herein the term “pairing” may be used to refer to the establishment of communication between the various devices as set forth herein. The communication protocol that the host device, guest device (if provided), sensor relay (if provided) may be based on conventional wireless communication protocols including WiFi, Bluetooth, cellular communications, and the like. In some non-limiting examples, a host device and/or a guest device may be a smart phone or other device capable of running software applications, tablets, laptops, desktops, and the like. In some non-limiting examples, the signal relay (if provided) may be configured to operate over Bluetooth, WiFi, cellular communication standards, and the like, and a non-limiting example of a signal relay may be an Apple Home device (e.g., Apple TV, HomePod, and the like), an Alexa-enabled device, and the like.

### BRIEF DESCRIPTION OF THE DRAWINGS

The subject matter of the present disclosure is best understood by reference to the drawings. Aspects of the present disclosure are illustrated by way of example and are not limited by the accompanying figures for which like references indicate like elements.

FIG. 1 illustrates a system for preventive water submersion detection, in accordance with an exemplary embodiment of the disclosure;

FIG. 2 is a block diagram that illustrates components the application server of FIG. 1, in accordance with an exemplary embodiment of the disclosure;

FIG. 3 illustrates an exemplary user interface rendered on the host device of FIG. 1, according to an aspect of the present disclosure;

FIG. 4 is a block diagram that illustrates the sensor device of FIG. 1, in accordance with an exemplary embodiment of the disclosure;

FIG. 5 illustrates another system for preventive water submersion detection, according to the present disclosure;

FIG. 6 illustrates another system for preventive water submersion detection including a signal relay, according to the present disclosure;

FIG. 7 illustrates another system for preventive water submersion detection including a signal relay, according to the present disclosure; and

FIGS. 8A and 8B are flow charts illustrating process steps performed by the systems for preventive water submersion detection, according to the present disclosure.

### DETAILED DESCRIPTION

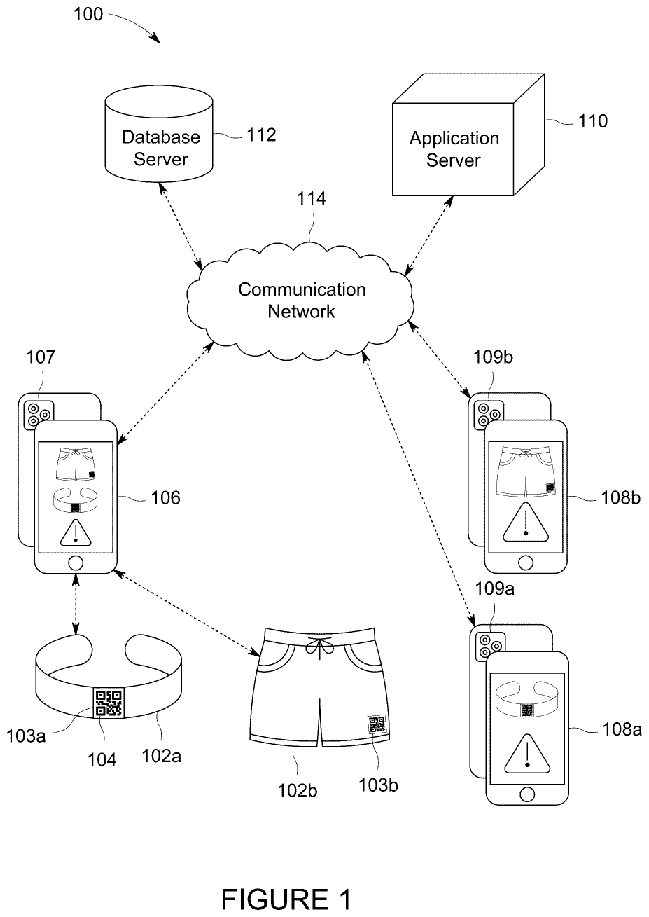

Systems and methods for water submersion detection comprising wearable devices with integrated submersion sensors and a machine-readable identifier (MID) designed to enhance personal safety and provide real-time alerts during potential water submersion incidents, are described hereinbelow in connection with FIGS. 1-8B. Those of ordinary skill in the art will understand exemplary embodiments are described herein, and other exemplary embodiments or features may further be utilized, and other changes may be made to the disclosed embodiments, without departing from the spirit or scope of the subject matter presented herein. In the following detailed description, reference is made to the accompanying drawings, which form a part thereof.

The exemplary embodiments described herein are not meant to be limiting. It will be readily understood the aspects of the present disclosure, as generally described herein, and illustrated in the drawings, may be arranged, substituted, combined, separated, and designed in a wide variety of different configurations, all of which are explicitly contemplated herein.

Other aspects, advantages, and salient features of the disclosure will become apparent to those skilled in the art from the following detailed description, which, taken in conjunction with the annexed drawings, discloses exemplary embodiments of the disclosure.

The terms and words used in the following description and claims are not limited to the bibliographical meanings and are used to enable a clear and consistent understanding of the disclosure. Accordingly, it should be apparent to those skilled in the art the following description of exemplary embodiments of the present disclosure are provided for illustration purpose only and not for the purpose of limiting the disclosure. The skilled person will be able to devise various arrangements that, although not explicitly described herein, embody the principles of the present disclosure. All the terms and expressions in the description are only for the purpose of understanding by the reader and should not be interpreted to limit the disclosure. Accordingly, those of ordinary skill in the art will recognize various changes and modifications of the embodiments described herein can be made without departing from the spirit and scope of the disclosure. In addition, descriptions of well-known functions and constructions are omitted for clarity and conciseness. Terms first, second, top, bottom, upper, lower and the like are used to differentiate between objects having the same terminology and are in no way intended to represent a chronological order, unless where explicitly stated otherwise. Moreover, all statements herein reciting principles, aspects, and embodiments of the disclosure, as well as specific examples thereof, are intended to encompass equivalents thereof.

Now with specific reference to the figures, FIG. 1 illustrates a system 100 for preventive water submersion detection, in accordance with an exemplary embodiment of the disclosure. The system environment 100 includes wearables 102a and 102b (hereinafter, “wearable(s) 102”), a host device 106, guest devices 108a and 108b (hereinafter, “guest device(s) 108”), an application server 110, and a database server 112. The host device 106, the guest devices 108, the application server 110, and the database server 112 may be coupled to each other via a communication network 114 such as a wide-area network (WAN) (e.g., one or more of a cellular network, internet, and the like) or a local area network (LAN) (e.g., one or more of a residential or commercial WiFi router, local Bluetooth-based network, Matter or Thread-enabled network, and the like).

The wearables 102 may be attached to or worn on the body of a user, for example, but not limited to, a child or other individual having an increased risk of water submersion, to detect water submersion if such an incident occurs. At least one of the wearables 102 may be attached to or worn on the body of the user, and it will be understood by a person skilled in the art that any number of wearables may be attached to or worn on one or more users, without deviating from the scope of the present disclosure. The wearables 102 may include sensor devices 103a and 103b (hereinafter, “sensor device(s) 103”), respectively.

Each sensor device 103 may include a machine-readable identifier (MID) 104 (e.g., one or more of a quick response (QR) code or other two-dimensional code, barcodes, RFID tag, or near-field communication (NFC) device), provided on the wearable. In some examples the MID 104 may be provided visibly on the wearable, such as printed on a piece of apparel. In other examples the MID 104 may be embedded within a housing on the wearable, or within the material or bulk of the wearable itself. As those of ordinary skill in the art will understand, a MID 104 is a type of machine-readable device that can store various information, such as URLs, codes, application programming interface (API) information, or other data, and may be quickly scanned (e.g., using a camera, a NFC reader, RFID reader, and the like) by a smartphone for instant access to such information, thereby allowing pairing and/or establishing communication between the host device, guest device (if provided), relay device (if provided), and the wearable having the sensor device 103 associated with MID 104. It will be further apparent to a person skilled in the art that although each sensor device 103 may include a first type of MID 104, each sensor device 103 may also comprise, additionally or alternatively, a second type of MID 104 including a QR code, Matter identification code, barcode, a radio-frequency identification (RFID) tag, a near-field communication (NFC) device, a Bluetooth antenna, a Wi-Fi antenna, or any other machine-readable device or protocol suitable for communicating or providing a unique identifier (UID) or other information from the each of sensor devices to the host device 106.

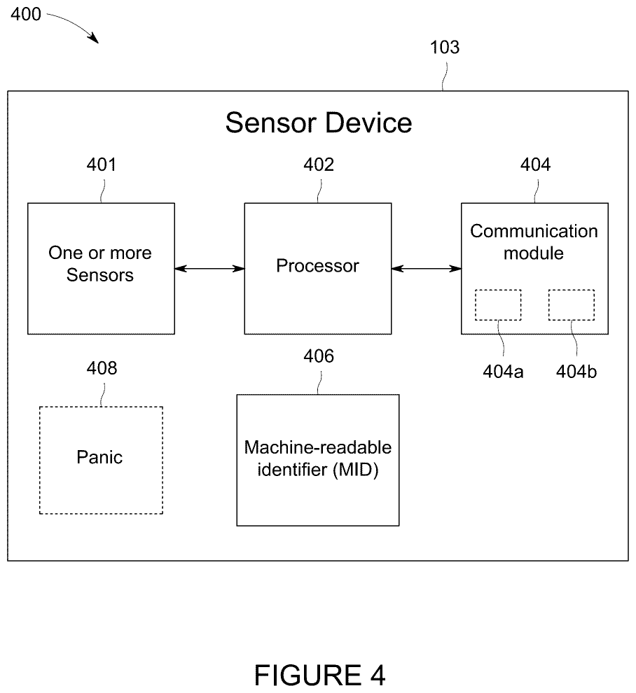

Each of the sensor devices 103 may include a submersion sensor (see, for example, submersion sensor 401 shown and described in connection with FIG. 4) to determine whether the user wearing the wearable 102 is experiencing a water submersion event or potential drowning incident. The submersion sensors described herein can comprise, but are not limited to, conductive sensors, signal strength sensor, PH sensor, capacitive sensors, pressure sensors, sonic sensors, oxygen sensors, optical sensors, and the like. According to one aspect of the present disclosure, the submersion sensor can be a pressure sensor that detects surrounding (e.g., water) pressure to determine if the user wearing the wearable 102 is experiencing a water submersion event or has otherwise become at least partially submerged in a body of water.

A pressure sensor may be appropriate to sense an actual water submersion, or deep submersion, condition, as the surrounding pressure in underwater environment is generally greater than the surrounding atmospheric pressure, and importantly water pressure increases significantly faster than air pressure as a function of distance.

According to another aspect of the present disclosure, water detection sensors relying on the electrical conductivity of water to, for example, change the electrical resistance across two electrical contacts can be configured to detect submersion of the sensor device 103. However, this type of sensor is an example of such sensors, and other types of electrical water detection sensors are contemplated within the scope of the present disclosure. Additional sensor devices may include sensors configured to determine a signal or communication link interrupt between the wearable and host device, guest device, and/or relay device. In some examples, such sensors may monitor signal to noise ratio, signal interference indicators, low-power indicators, signal strength indicators, and the like.

According to further aspects of the present disclosure, the sensor device 103 can comprise a timer, such that the sensor device 103 can determine how long the wearable 102 has been in contact with or submerged under the water, which can provide a more accurate indication of a more concerning water submersion event. The elapsed time, measured by such a timer, may also be used to indicate the potential severity of a submersion event. Accordingly, there may be multiple alert types corresponding to, for example, an estimated severity of the submersion event. For example, a first alert level may indicate water submersion while a second, a second alert level may indicate a more severe submersion event such as one lasting longer than a predetermined amount of time, corresponding to an increased drowning risk. Additional variations of sensor device 103, suitable for determining submersion of the wearables 102 in a body of water, will be apparent to those of ordinary skill in the art and can be employed by the systems and methods disclosed herein without departing from the scope and spirit of the present disclosure.

In one embodiment, the sensor devices 103 may sense water submersion of the user wearing the wearable 102 based on a predefined threshold (e.g., a pressure threshold, conductivity threshold, connection-loss detection thresholds, signal strength threshold, signal quality threshold, and the like) such that the sensor devices 103 may generate the detection information indicating water submersion of the user when a value of the detection information exceeds or fails to meet the predefined threshold. For example, the threshold can be configured such that water pressure corresponding to a depth less than two feet does not trigger a water submersion condition alert or triggers a first alert level, whereas water pressure corresponding to depths greater than or equal to two feet do trigger a water submersion condition alert or a second alert level. Of course, two feet represents an exemplary depth/pressure and those of skill in the art will understand any number of other thresholds or combination of thresholds can be configured to trigger a water submersion condition alert.

The MIDs 104 associated with the wearables 102 may include within the machine-readable information a unique identification number (UID) assigned to a wearable 102 or sensor device 103. The UID may be a combination of letters and numbers ensuring unique identity of each of the wearables 102. According to aspects of the present disclosure, the MIDs 104 on the wearables 102 can be utilized for identification of the wearables 102 and for communication purposes. The MIDs 104 on the wearables 102 may be scannable or otherwise paired to the host device 106 and/or the guest devices 108, if provided. As shown in FIG. 1, an example of the wearable 102a corresponds to a bracelet, headband, or wristband and the wearable 102b corresponds to clothing apparel, such as, for example, a pair of shorts. Additional examples of the wearables 102 may include, but are not limited to, waistbands or belts, articles of jewelry, shirts, pants, jackets or other outerwear, shoes, diapers, or the like. Sensor devices 103 may be integrated within a wearable devices, printed on an exterior of the wearable device, provided on a tag of the wearable device, or may be clipped to wearable devices.

In yet another embodiment, each wearable 102 may further comprise a manual panic input, such as a push-button, capacitive touchpad, or squeeze-activated sensor, configured to trigger an alert condition upon user activation. In the example of a capacitive touchpad, the capacitive touchpad may also be configured as the submersion sensor, wherein a change in capacitance due to submersion may constitute a submersion sensor. The panic button input can be integrated with the same communication module that transmits water-sensor data or signal-loss alerts, enabling manual alert signaling regardless of whether a submersion event or signal loss has occurred. This feature can be particularly beneficial for older children or adults capable of self-initiating a rescue alert but may also ensure safety of at-risk individuals such as young children if an unsafe situation or injury occurs.

According to one exemplary embodiment, the wearables 102 can comprise diapers for infants and young children. According to such embodiment, each individual diaper could be provided with a submersion sensor and MID, the MID corresponding to a UID as discussed above. Alternatively, all diapers within a box of diapers, or even a larger quantity, could be provided with identical MIDs to streamline manufacturing of the diapers. Furthermore, the submersion sensor and MID could be provided on a location of the diaper that is unlikely to be exposed to moisture, such as, for example, the waistband or an exterior surface of the diaper. Alternatively, the submersion sensor could be positioned on an interior of the diaper, such that the submersion sensor is triggered to alert a parent when an infant needs to be changed.

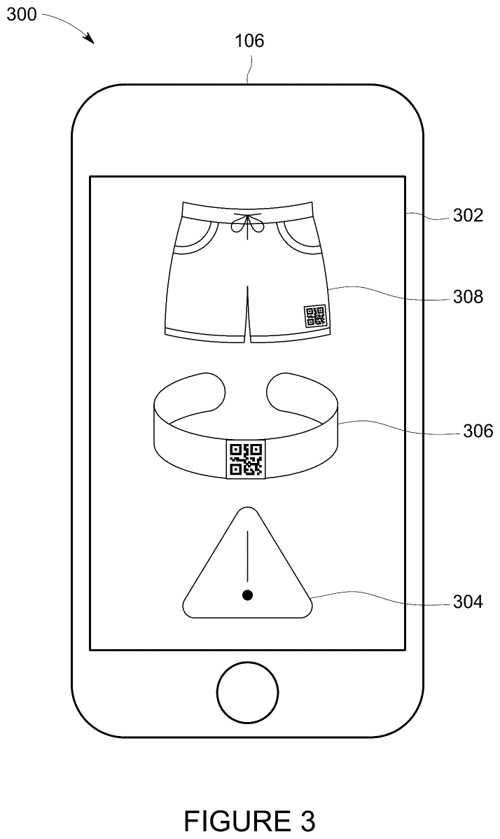

The host device 106 and guest device 108 may include suitable logic, circuitry, interfaces, and/or code, executable by one or more processors, configured to store and/or execute a software application and generate a user interface (e.g., user interface 302, shown and described in connection with FIG. 3) to facilitate interaction with a user of the host device 106 and guest device 108, respectively. For example, as shown in the figures, the host device 106 and guest device 108, if provided, can be a mobile computing device, such as, but not limited to a cellular telephone, a tablet, a laptop, or the like.

According to some embodiments of the present disclosure, the host device 106 can be located adjacent to the body of water and within direct communication range of the wearables. According to other embodiments of the present disclosure, the host device 106 need not be located adjacent to the body of water, or within direct communications range of the wearables. A UID may also be assigned to the host device 106 that may be a combination of letters and numbers ensuring unique identity of the host device 106. As shown, the host device 106 can include a scanner 107 (e.g., camera, NFC reader, RFID reader, and the like) configured to scan the MIDs 104 corresponding to the sensor devices 103 and wearables 102, to associate the host device 106 with the wearables 102. According to embodiments of the present disclosure, the host device 106 can be associated, or paired, with multiple wearables 102 by scanning the MIDs 104 provided with each.

The host device 106 may be wirelessly coupled or otherwise paired or hardwired to the application server 110 by way of the communication network 114. In some examples the application server 110 may be provided in the host device 106. The host device 106 may be configured to transmit the UID of the host device 106, the scanned MIDs 104 of the wearables 102, and connection status and/or detection information from the sensor devices 103 to the application server 110 via the communication network 114. The host device 106 may be wirelessly coupled or paired to the sensor devices 103 by way of wireless communication technology, such as, but not limited to, Bluetooth, Wireless Fidelity (Wi-Fi), Bluetooth Low Energy (BLE), and the like. The host device 106 may be configured to receive detection information from the sensor devices 103. In an embodiment, the detection information may include submersion sensor data received from the sensor devices 103/104 indicating detection of water submersion by the sensor devices 103/104. The host device 106 may be configured to transmit the detection information received from the sensor devices 103/104 to the application server 110 via the communication network 114. The host device 106 may be further configured to receive alert notifications from the application server 110 via the communication network 114. Furthermore, as will be discussed below, the system 100 may also be configured to generate an alert notification when a communication link between the wearable 102 and sensor device 103 is lost, degraded, or determined to be unreliable. Similarly, the system 100 may also generate an alert notification when a signal from the wearable 102 or sensor device 103 is not received after a predetermined period of time.

The guest devices 108 may include suitable logic, circuitry, interfaces, and/or code, executable by one or more processors, configured to store and/or execute a software application and generate a user interface to facilitate interaction with a user of the guest devices 108. For example, as shown in the figures, the guest devices 108 can each be a mobile computing device, such as, but not limited to a cellular telephone, a tablet, a laptop, or the like. The guest devices 108 may be located remotely from the wearables 102 and need not be in direct communication with the wearables 102 after an initial pairing procedure. A UID may be assigned to each of the guest devices 108, which may be a combination of letters and numbers ensuring unique identity of the guest devices 108. The guest devices 108 may include scanners (hereinafter, “scanner(s) 109”), configured to scan the MIDs 104 embedded within or provided (e.g., sewn, printed, and the like) on to the wearables 102 to associate each the guest devices 108 with the MIDs 104 of the respective wearables 102.

For example, as shown in FIG. 1, guest device 108a is paired to wearable 102a and receives information and alerts relating to wearable 102a, and guest device 108b is paired to wearable 102b and only receives information and alerts relating to wearable 102b. Moreover, host device 106 may be paired to or associated with both wearable 102a and wearable 102b and receives information and alerts relating to both of the wearables 102. The guest devices 108 may be in wireless communication with the respective sensor devices 103 via the host device 106 and the communication network 114, or may be configured to be in direct contact with the wearables 102.

With continued reference to FIG. 1, the guest devices 108 may be wirelessly coupled to the application server 110. For example, the guest devices 108 may be configured to transmit the UID of the guest devices 108, corresponding to the scanned MIDs 104, of the wearables 102 to the application server 110 via the communication network 114. The guest devices 108 are configured to receive the alert notifications from the application server 110 via the communication network 114. It will be apparent to the person skilled in the art that although two guest devices 108 are shown in FIG. 1, system 100 may comprise any number of guest devices 108, without deviating from the spirit and scope of the present disclosure.

The application server 110 may include suitable logic, circuitry, interfaces, and/or code, executable by a processor, which may be configured to perform one or more operations associated with preventive water submersion detection. The application server 110 may be a computing device, which may include a software framework that may be configured to create the application server 110 implementation and perform the various operations associated with the preventive water submersion detection described herein. The application server 110 may be realized through various web-based technologies, such as, but are not limited to, a Java web-framework, a .NET framework, a PHP framework, a python framework, or any other web-application framework. As discussed above, the application server 110 may be included in a host device 106 or may be remote from the host device 106.

The application server 110 may also be realized as a machine-learning model that implements any suitable machine-learning techniques, statistical techniques, or probabilistic techniques. Examples of such techniques may include, without limitation, expert systems, fuzzy logic, support vector machines (SVM), Hidden Markov models (HMMs), greedy search algorithms, rule-based systems, Boolean data matrix, Bayesian models (e.g. Bayesian networks), neural networks, decision tree learning methods, other non-linear training techniques, data fusion, utility-based analytical systems, or the like. Examples of the application server 110 may include, but are not limited to, a personal computer, a laptop, or a network of computer systems.

The application server 110 may be configured to receive the UID of the host device 106, the scanned MIDs 104 of the wearables 102 directly from the wearable 102 or from the host device 106, and status information of the wearables 102 from the host device 106 via the communication network 114. In some examples status information may be in the form of a periodic signal (e.g., a “ping”) from the wearable 102 or may be an indication that a connection between the wearable 102 and application server 110 is present (or, by inference, if a signal from the wearable 102 has been lost). The application server 110 may be configured to retrieve the UID of the wearables 102 scanned by the host device 106.

The application server 110 can also be configured to receive the UIDs of the guest devices 108 and the scanned MIDs 104 of the wearables 102 from the guest devices 108 paired to the respective wearables 102, via the communication network 114. The application server 110 may be configured to retrieve the UID of the wearables 102 from the MIDs 104 of the wearables 102 scanned and thereby paired to by the guest devices 108.

Further, the application server 110 may be configured to associate, or pair, the UID of the host device 106 and the UIDs of the guest devices 108 with the UID of the wearables 102. For example, as shown in FIG. 1, the UID of the host device 106 is associated with the UID of the guest devices 108 and the UID of the wearables 102, the UID of the guest device 108a is associated with the UID of the host device 106 and the UID of the wearable 102a, and the UID of the guest device 108b is associated with the UID of the host device 106 and the UID of the wearable 102b.

In some examples the UIDs of the associated guest devices 108, host devices 106, and wearables 102 may be stored in a local storage device as a structured data set, such as a data set including a plurality of rows and columns including UIDs and other information about associated devices. The application server 110 may be further configured to transmit the UID of the host device 106 and the UID of the guest devices 108 associated with the UID of the wearables 102 to a database server 112 via the communication network 114.

Further, the application server 110 may be configured to receive the detection information from the host device 106 via the communication network 114. When detection information from one of the wearables 102 indicates that water submersion is detected, the application server 110 can transmit alert notifications to the host device 106 and the particular guest device 108 associated with the wearable 102 indicating a water submersion event, based on the association of the UIDs of the host device 106, the guest devices 108, and the wearables 102.

The application server 110 may be configured to render a user interface or cause a tactile or audible alarm indicating the alert notifications on the host device 106 and the respective guest devices 108 that are associated with the wearables 102. For example, when the user wearing a wearable 102 is water submersion, the sensor device 103 may sense the water submersion of the user and generate detection information indicating that the user wearing the wearable 102 is water submersion.

According to another example, when the user wearing a wearable 102 is water submersion, the sensor device 103 may transmit sensor data (e.g., detection information) to the application server 110, and the application server 110 can process the sensor data to determine whether the user wearing the wearable 102 is water submersion. Furthermore, when the application server 110 receives information that indicates the user wearing the wearable 102 is experiencing a water submersion or drowning event, the application server 110 may send a notification alert to the host device 106 and the guest device 108 associated with the wearable 102 based on the association of the UIDs of the host device 106, the guest device 108, and the wearable 102. Alternatively, the system 100 may be configured to allow direct communication between the wearable 102 and host device 106, such that an alert may be transmitted directly to the host device 106.

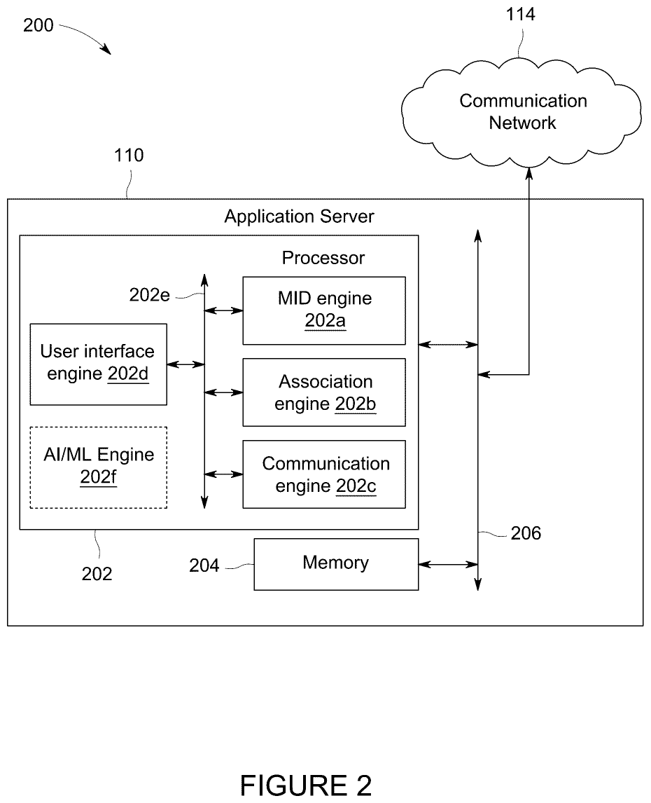

According to an embodiment, the application server 110 can further include or communicate with a machine learning module 202f (see FIG. 2) configured to enhance accuracy of water submersion detection and loss-of-signal interpretation. The machine learning module can analyze temporal patterns in sensor data (e.g., detection information), connectivity logs, and environmental parameters to distinguish between transient interference causing signal loss and genuine alert conditions. By learning historical device behavior, the module can dynamically adjust thresholds for signal loss duration, noise filtering, and water detection sensitivity to reduce false-positive alerts and alert fatigue while improving responsiveness to real incidents. The training model used by the learning module 202f can be periodically updated using anonymized operational data from multiple users to refine detection reliability across varying network conditions and environments.

The database server 112 may include suitable logic, circuitry, interfaces, and/or code, executable by one or more processors, which may be configured to perform one or more database operations, such as receiving, storing, processing, and transmitting data, or content. The database server 112 may be a data management and storage computing device that is communicatively coupled to the host device 106, the guest devices 108, and the application server 110 via the communication network 114 to perform the one or more database operations. Examples of the database server 112 may include, but are not limited to, a personal computer, a laptop, a cloud storage server location, or a network of computer systems.

According to some aspects of the present disclosure, database server 112 may be configured to receive the UID of the host device 106 and the UID of the guest devices 108 associated with the UID of the wearables 102 from the application server 110. The database server 112 may be configured to manage and store the UID of the host device 106 and the UID of the guest devices 108 associated with the UID of the wearables 102. The database server 112 may be further configured to generate a data structure including one or more rows and columns for storing the UID of the host device 106 and the UID of the guest devices 108 associated with the wearables 102 in a structured manner. For example, each row may be associated with the UID of each wearable 102, and one or more columns corresponding to each row may indicate the UID of the host device 106 associated with each wearable 102 and the UIDs of the guest devices 108 associated with each wearable 102.

The communication network 114 may include suitable logic, circuitry, interfaces, and/or code, executable by one or more processors, that may be configured to transmit data, messages, and notifications between various entities, such as the host device 106, the guest devices 108, the application server 110, the database server 112 and the wearables 102 (e.g., as discussed in connection with FIGS. 1 and 5-7). Examples of the communication network 114 include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. Furthermore, communication network 114 can employ one or more wired and/or wireless modes of communication. In some examples, satellite communication protocols may also be implemented to ensure communication is maintained even if other types of wireless communication protocols are unavailable.

Additional non-limiting examples of communication network 114 include a wireless fidelity (Wi-Fi) network, a cellular network, a light fidelity (Li-Fi) network, a metropolitan area network (MAN), a satellite network, a fiber optic network, a coaxial cable network, an infrared (IR) network, a radio frequency (RF) network, a Thread or Matter-based communication protocol, and a combination thereof. Those of ordinary skill in the art will understand various entities in the system environment 100 may connect to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

To this point, the system and method disclosed in FIG. 1 have discussed examples of active submersion detection, such as using sensors 103 configured to detect water, water pressure, conductivity changes, pressure changes, and the like. However, traditional communication protocols, such as WiFi, Bluetooth, Threads, Matter, and the like, generally do not transmit well through media such as water. And when the signals can transmit well through such media, the signals may experience significant degradation in quality, severe signal attenuation, frequency shifts, and the like, at boundaries between two media having different densities and/or electromagnetic propagation speeds. For example, a WiFi or Bluetooth signal transmitted underwater may be almost entirely reflected at the water-to-air boundary, causing a severe loss in signal quality, strength, and/or complete lack of reception at a receiver above the surface of the water. Communication protocols and transceiver designs such as magneto-inductive (MI), low frequency electromagnetic wavelengths, and optical (e.g., light-based) signal transmission and communication protocols are contemplated within the present disclosure. Such communication protocols, combined with an appropriate antenna design, can transmit underwater signals to above-water receivers. However, the transmission distance may be only several meters to tens of meters and thus may not be appropriate for larger system coverage areas. However, for many uses of the disclosed system such as in residential settings, small commercial environments, campsites, backyards, beaches, and the like, such technologies may be used to reliably maintain signal and message transmission between underwater and above-water transceivers.

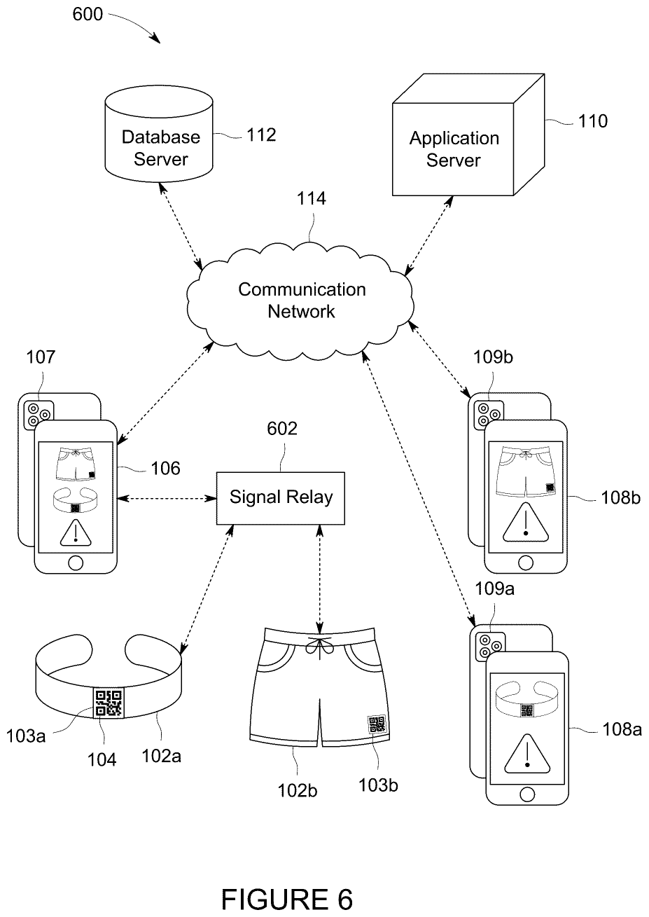

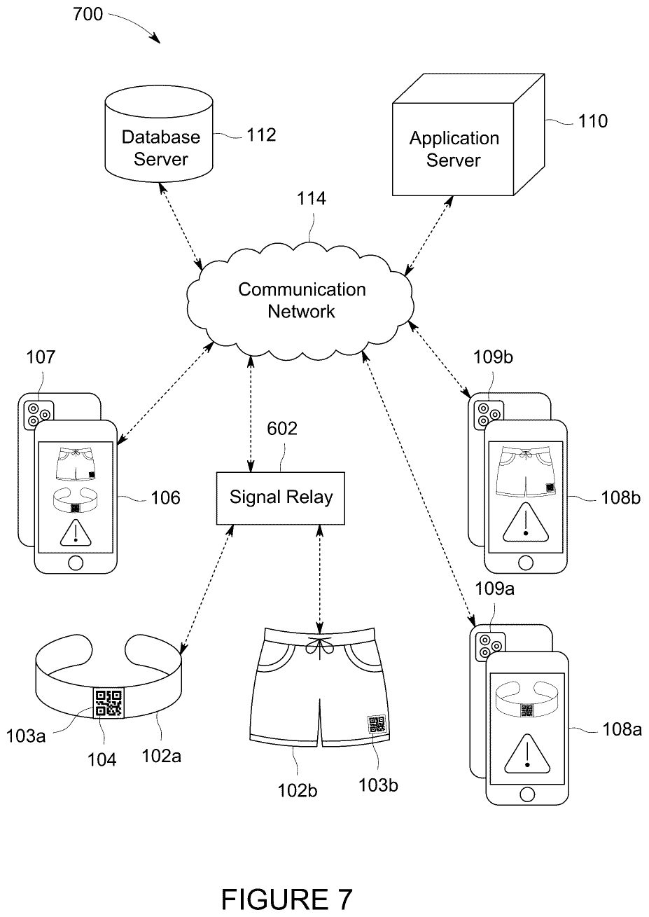

Furthermore, as will be discussed below, a signal relay device (such as, for example, signal relay 602 in FIGS. 6 and 7), may be positioned proximate to the edge of the water, or otherwise proximal to the body of water, to ensure reliable connectivity with a wearable 102 and thereby ensure reliable submersion detection and alert generation. In some examples, the wearable 102 and/or sensor 103 may include a transceiver 404B (see FIG. 4) configured for underwater signal transmission. The underwater signal transceiver 404B (such as, without limitation, a magneto-inductive transceiver and antenna) of the wearable 102 may be provided in addition to or instead of the WiFi, cellular, Bluetooth, or other transceiver module 404A. The underwater signal transceiver 404B may be configured to establish communication with a compatible transceiver on a signal relay device floating in the water or on land within the transmission and reception range of the underwater signal transceiver 404B on the wearable 102. The signal relay device may further be configured to convert or translate the underwater signal to a different communication protocol, such as a Wifi, cellular, and/or Bluetooth protocol as previously discussed. This water-to-air transmission capability enables reliable data transfer from submerged wearables 102 to above-surface receivers, such as signal relay(s), host devices 106, and/or guest device 108. The communication module 404 provided on the wearable 102 may thus include a dual-band transceiver configured for underwater acoustic, magnetic-inductive, or low-frequency RF communication below the waterline, and optical, RF, or Wi-Fi transmission above the waterline.

In some embodiments, a floating signal relay provided in the body of water may communicate directly with wearable 102 and the host device 106, guest device 108, or the application server 110. In other examples the floating signal relay may communicate with a shore-based receiver positioned adjacent to the body of water, which in turn relays the data to the application server 110, host device 106, or guest device 108. Such configurations enable continuous monitoring even when the wearable 102 is fully submerged, obstructed by water turbulence, or otherwise outside normal communication range of a host device 106 or application server 110. In some embodiments, multiple floating signal relays can form a mesh network, increasing coverage and signal robustness in larger aquatic environments.

In other embodiments, the system 100 can be configured to treat a loss of communication signal as an indication of a water submersion event, drowning event, and the like. In response to the determination that communication with the wearable 102 has been lost, the system 100 may trigger an alert to be generated to the device(s) associated with the wearable 102 experiencing the loss of communication. That is, if the signal, communication link, or other connection between the wearable(s) 102 and one or more of the host device 106, guest device 108, and/or signal relay(s), is lost, interrupted, interfered with, or otherwise impeded, all or a subset of the devices may be alerted to a potential water submersion or submersion event.

In some examples, the application server 110, guest device(s) 108, the host device(s) 106, and/or a signal relay device can be configured to monitor the continuity, signal characteristics, temporal and spatial variation of the signal, signal to noise ratio, and/or received power level (herein referred collectively as “signal quality”) of the communication signal with the wearable 102. In some examples, if such signal is not received after a predefined or threshold interval of time has passed (e.g., 1 seconds, 2 seconds, 3 seconds, 5 seconds, 10 seconds), an alert notification can be automatically generated. In other examples, if signal quality degrades sufficiently that the signal is unidentifiable, unusable, incoherent, or otherwise unreliable, an alert may be generated. In some examples, a signal to noise ratio threshold may be used, wherein when an SNR value of the wearable 102 signal drops below a threshold, an alert may be generated by the system 100. It is noted the loss-of-signal alert may supplement or replace a submersion-triggered alert, enabling detection of situations where the wearable 102 loses signal without necessarily being submerged, but where a user may want to check on the user associated with the wearable 102.

FIG. 2 is a block diagram 200 that illustrates hardware and software components of the application server 110, in accordance with an exemplary embodiment of the present disclosure. The application server 110 includes circuitry such as a processor 202 and a memory 204 that communicate with each other by way of a first communication bus 206.

The processor 202 may comprise suitable logic, circuitry, interfaces, and/or code, executable by the circuitry, which may be configured to perform one or more operations associated with the water submersion detection. Examples of the processor 202 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the processor 202 may be compatible with multiple operating systems.

According to some aspects of the present disclosure, the processor 202 may be configured to control and manage various functionalities and operations such as machine-readable identifier (MID) retrieval, associating the UID of the respective MID with the UIDs of other devices, and transmitting notifications associated with the preventive water submersion detection. The various functionalities and operations may be controlled and managed by one or more internal hardware or software components of the processor 202, such as a MID engine 202a, an association engine 202b, a communication engine 202c, a user interface engine 202d, and an artificial intelligence/machine learning (AI/ML) engine 202f that communicate with each other by way of a second communication bus 202e. In some embodiments, the processor 202 may operate as a master processing unit, and the MID engine 202a, an association engine 202b, a communication engine 202c, and the user interface engine 202d may operate as slave processing units. In such a scenario, the processor 202 may be configured to instruct the MID engine 202a, an association engine 202b, a communication engine 202c, and the user interface engine 202d to perform their corresponding operations either independently or in conjunction with each other.

The MID engine 202a may include suitable logic, circuitry, interfaces, and/or code, executable by one or more processors, which may be configured to perform the one or more operations for scanning and retrieving the UID of the wearables 102. The MID engine 202a may be configured to receive the scanned MIDs of the wearables 102 from the host device 106 via the communication network 114. The MID engine 202a may be configured to retrieve the UID of the wearables 102 from the scanned MIDs of the wearables 102 received from the host device 106. The QR engine 202a may be further configured to receive the scanned MIDs of the wearables 102 from the guest devices 108 via the communication network 114. Further, the MID engine 202a may be configured to retrieve the UID of the wearables 102 from the scanned MIDs of the wearables 102 received from the guest device 108. Additionally, the MID engine 202a may be configured to transmit the UID of the wearables 102 to the association engine 202b.

The association engine 202b may include suitable logic, circuitry, interfaces, and/or code, executable by one or more processors, which may be configured to perform the one or more operations associated with associating the UID. The association engine 202b may be configured to receive the UID of the host device 106 from the host device 106 via the communication network 114. The association engine 202b may be further configured to receive the UID of the guest devices 108 from the guest devices 108 via the communication network 114. Further, the association engine 202b may be configured to receive the UID of the wearables 102 from the MID engine 202a.

Additionally, the association engine 202b may be configured to associate the UID of the host device 106 and the UID of the guest devices 108 with the UID of the wearables 102 and transmit the UID of the host device 106 and the UID of the guest devices 108 associated with the UID of the wearables 102 to the database server 112 via the communication network 114. Based on the association of the UID, the association engine 202b may be configured to transmit the alert notifications to the host device 106 and the respective guest devices 108 that are associated with the wearables 102.

The communication engine 202c may include suitable logic, circuitry, interfaces, and/or code, executable by one or more processors, that may be configured to perform the one or more operations associated with establishing communication among the sensor devices 103, the host device 106, and the guest devices 108. For example, the communication engine 202c can establish communication between the application server 110 and the host device 106, one or more of the guest devices 108, one or more of the sensor devices 103, a signal relay (e.g., signal relay 602, described in connection with FIG. 7), or other devices within the system environments described herein via the communication network 114. According to some aspects of the present disclosure, the communication engine 202c may provide for communication between the sensor devices 103 and the host device 106 utilizing short range communication technology that includes, but are not limited to, Bluetooth, Zigbee, Matter, Thread, near field communication (NFC), and the like. According to additional aspects of the present disclosure, the communication engine 202c may establish communication between the sensor devices 103 and the respective guest devices 108 utilizing long range communication technology that include, but are not limited to, Wi-Fi, cellular, and the like.

The user interface engine 202d may include suitable logic, circuitry, interfaces, and/or code, executable by one or more processors, which may be configured to perform the one or more operations associated with displaying notifications on the host device 106 and the guest devices 108. When the host device 106 and the guest devices 108 receive the alert notifications (e.g., water submersion event notification, such as notification 304 shown and described in connection with FIG. 3), the user interface engine 202d may be configured to display the alert notifications utilizing the user interface rendered on the host device 106 and the guest devices 108 that are be associated with the wearables 102. It is noted that the user interface engine 202d may also be configured to generate tactile and/or audible alerts in addition to or in place of visual alerts.

The memory 204 may comprise a non-transient computer readable media including suitable logic, circuitry, interfaces, and/or code, executable by the circuitry, that may be configured to store one or more instructions that are executed by the processor 202, the MID engine 202a, an association engine 202b, a communication engine 202c, and the user interface engine 202d to perform their operations. In an exemplary embodiment, the memory 204 may be configured to temporarily store the UID of the host device 106 and the UID of the guest devices 108 associated with the UID of the wearables 102. Examples of the memory 204 may include, but are not limited to, a random-access memory (RAM), a read-only memory (ROM), a programmable ROM (PROM), and an erasable PROM (EPROM).

FIG. 3 is a block diagram 300 that illustrates an exemplary user interface 302 rendered on the host device 106, according to an aspect of the present disclosure. The user interface engine 202d may be configured to display or emit the transmitted alert notifications utilizing the user interface 302 on the host device 106 and the guest devices 108. In an embodiment, the user interface 302 presents the alert notifications in the form of visual alerts that include a warning sign 304 and pictorial representations 306 and 308 of the wearables 102 associated with the host device 106 (e.g., as shown in FIG. 1). In other examples the alert notification may be an audible sound or tactile vibration to draw a user's attention to the alert condition. The transmitted alert notifications may be in formats that include, but are not limited to, pop-up message alerts, flash message alerts, video alerts, visual alerts, animated alerts, beeps, vibration patterns, and the like. According to some embodiments, the transmitted alert notifications may be rendered in formats that include, but are not limited to, text-to-speech alerts or a combination of previously-discussed alert notification types.

A similar user interface is rendered on the guest devices 108, presenting the alert notifications in the form of visual, audible, or tactile alerts that include a representation of each wearable 102 associated with the guest device 108. Notably, the user interface 302 generated on the host device 106 differs from the user interface presented on the guest devices 108 in that the user interface 302 generated on the host device 106 presents notifications for all wearables 102 connected to the system 100 (e.g., wearable 102a and wearable 102b), whereas the user interface generated on the guest devices 108 presents only the notifications for the wearables 102 associated with each guest device 108. For example, as shown in FIG. 1, guest device 108a only presents notifications for associated wearable 102a and guest device 108b only presents notifications for associated wearable 102b.

FIG. 4 is a block diagram 400 that illustrates hardware and software components of the sensor device 103, in accordance with an exemplary embodiment of the disclosure. The sensor device 103 includes circuitry such as one or more sensors 401, a processor 402, and a communication module 404. The sensor device 103 further includes a MID 406 (which may correspond to MID 104 in FIG. 1), for example, provided on an exterior housing of the sensor device 103 or elsewhere on the wearable 102. As previously discussed, a panic mode input 408 may be provided with the sensor device 103 to allow for a manual alert notification to be generated on the devices associated with the wearable 102 and sensor device 103.

As discussed herein, the sensor device 103 is attached to or embedded in the wearable 102. The one or more sensors 401 may include at least one of a submersion sensor and a pressure sensor. Those of ordinary skill in the art will understand that other sensors can be used to detect a water submersion or submersion event, including, but not limited to, sensors that detect a difference between the conductance, capacitance, or ability to transmit a signal between air and water (e.g., as shown and described in connection with sensor device 103 of FIG. 1). Such losses of signal, link, or connection may be, per se, an indicator of a submersion or water submersion event, as discussed above. Examples of the submersion sensor may include, but are not limited to, conductivity-based, pressure, and capacitive sensors. The capacitive sensors may measure changes in capacitance caused by the presence of water. As discussed above, when water is detected, the change in capacitance triggers the sensor.

The processor 402 may include suitable logic, circuitry, interfaces, and/or code, executable by the circuitry, which may be configured to perform one or more operations associated with the detection information generated by the sensor device 103. Examples of the processor 402 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the processor 402 may be compatible with multiple operating systems.

The processor 402 may be configured to receive submersion sensor data, i.e., detection information, from the sensor 401. The submersion sensor data received from the sensor 401 can be processed by the processor 402 to determine whether a water submersion event is occurring. Additionally, or alternatively, the processor 402 may be configured to transmit the detection information to one or more of the host device 106, a guest devices 108, or the application server 110 utilizing the communication module 404. According to some aspects of the present disclosure, the processor 402 is configured to receive pressure sensor data, i.e., detection information, from the sensor 401. The pressure sensor data received from the sensor 401 is processed by the processor 402, and the processor 402 transmits the pressure sensor data to one or more of the host device 106, associated guest device(s) 108, and the application server 110 utilizing the communication module 404.

The communication module 404 may include suitable logic, circuitry, interfaces, and/or code, executable by one or more processors, that may be configured to perform the one or more operations associated with transmitting the submersion sensor data from the sensor device 103 to one or more of the host device 106, associated guest device(s) 108, and the application server 110. Examples of the communication protocols utilized by communication module 404 can include, but are not limited to, Wi-Fi, Bluetooth, Zigbee, and NFC. As discussed above, in some examples communication module 404 may include a first transceiver 404a configured for above-water communication and a second transceiver 404b configured for above-water communication.

Furthermore, in some embodiments, the system 100 can be configured to selectively operate in a low-power mode, either manually activated by a user via the host device 106 and/or automatically based on schedule, rule set, or countdown timer. In some examples, the low-power mode command may be communicated to or transmitted to at least one of the host device(s) 106, guest device(s) 108, signal relay(s) 602, or sensor(s) 103 on wearable(s) 102. In this mode, the wearable 102, host device 106, guest device 108, and/or signal relay 602 can be configured to reduce transmission frequency, transmission power, duty cycle, or ping rate to conserve energy. One or more of the host device 106, guest device 108, and signal relay 602 may, when the low-power mode is commanded, adjust the threshold for signal quality, monitoring frequency, or reception frequency accordingly to ensure that a sensor 103 in low-power mode does not inadvertently cause an alert notification to be generated in normal operation discussed previously. In some examples, certain signal strength and/or signal quality parameters may indicate that the battery in the sensor device 103 is getting low, and may be used to generate a low-battery alert.

In a non-limiting example, in normal operating mode (that is, not in low-power mode), the devices may exchange pings, communication protocol messages, or other signals once every second, and may trigger an alert when no response is received within, for example, two seconds. Whereas in an example of low-power mode operation, signal transmission and monitoring intervals may be extended to one or two minutes thereby drastically reducing the battery drain on the sensor 103 or in other battery-powered devices in system 100. This configuration provides an adjustable balance between battery life and connection integrity, particularly suitable for overnight or other idle periods.

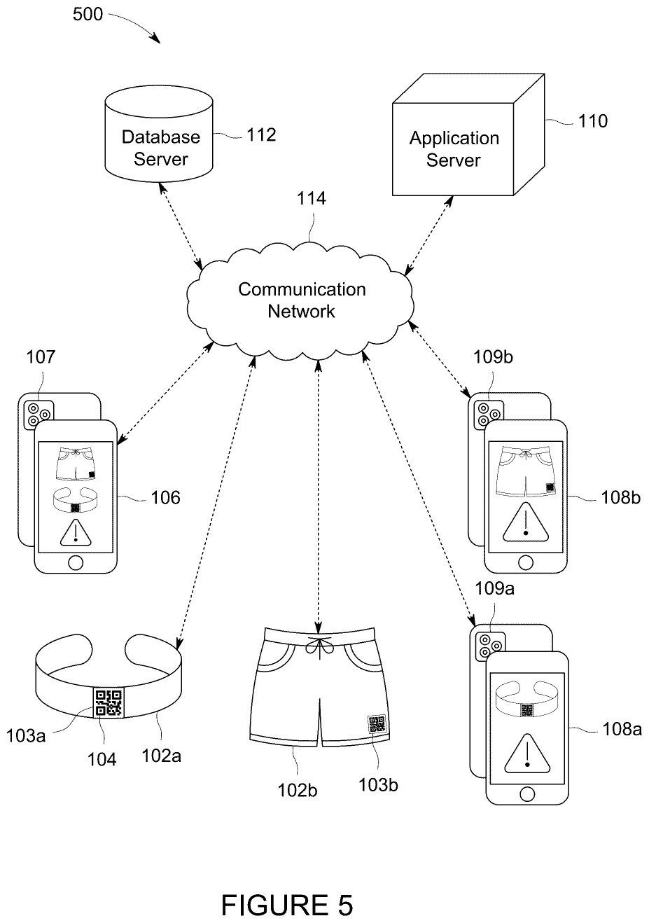

FIG. 5 illustrates a system environment 500 for preventive water submersion detection, according to another aspect of the present disclosure. System 500 is substantially similar to system 100, but for distinctions noted herein. Accordingly, similar reference numerals of system 500 indicate similar hardware and software components as those of system 100, shown and described in connection with FIG. 1. As shown in FIG. 5, the system environment 500 includes the wearables 102, the host device 106, the guest devices 108, the application server 110, and the database server 112. The wearables 102, the host device 106, the guest devices 108, the application server 110, and the database server 112 may be coupled to each other via the communication network 114.

As shown in FIG. 5, the UIDs and data from the sensor devices 103 embedded in the wearables 102 can be transmitted to the application server 110 via the communications network 114, the application server 110 can match the UIDs of the wearables 102 to the associated host device 106 and determine whether a water submersion event is occurring, and the application server 110 can transmit the data from the sensor devices 103 and/or notifications relating to a water submersion event to the associated host device 106 via the communication network 114. Furthermore, the application server 110 can match the UIDs of the wearables 102 to one or more associated guest devices 108 and the application server 110 can transmit the data from the sensor devices 103 and/or notifications relating to a water submersion event to the associated guest devices 108 via the communication network 114. Accordingly, the application server 110 transmits data and/or notifications relating to a water submersion event from all of the wearables 102 of system 500 to host device 106 and the application server 110 transmits data and/or notifications relating to a water submersion event from the wearables 102 of system 500 to guest devices 108 associated therewith via the communication network 114.

Notably, system 500 differs from system 100 in that the one or more wearables 102 are not in direct communication with the host device 106 but are in communication with the host device 106 indirectly via the communication network 114. The network topology of system 500 is advantageous where the host device 106 is outside of communications range with the wearables 102 or may not be within communications range of the wearables 102 on a continuous basis. Accordingly, by communicating indirectly via the communication network 114, the host device 106 can continue to monitor the wearables 102 without being required to be within direct communications range of the wearables. According to one exemplary embodiment, the wearables 102 can be connected to the communication network 114 via a Bluetooth or low-power Wi-Fi connection and the host device 106 can be a mobile telecommunications device (e.g., an iPhone) connected to the communication network 114 via a cellular network connection, thereby allowing the host device 106 to travel outside of the communications range defined by the wireless protocol utilized by the wearables 102 (e.g., Bluetooth or low-power Wi-Fi). Those of ordinary skill in the art will understand that numerous communication protocols and technologies can be utilized to establish connections between the wearables 102, the host device 106, and the guest devices 108 with the communication network 114 according to the network topology shown and described in connection with FIG. 5, without departing from the spirit and scope of the present disclosure.

FIG. 6 illustrates a system environment 600 for preventive water submersion detection, according to yet another aspect of the present disclosure. System 600 is substantially similar to system 100, but for distinctions noted herein. Accordingly, similar reference numerals of system 600 indicate similar hardware and software components as those of system 100, shown and described in connection with FIG. 1. As shown in FIG. 6, system environment 600 includes the wearables 102, the host device 106, the guest devices 108, one or more signal relays 602, the application server 110, and the database server 112. The host device 106, the guest devices 108, the application server 110, and the database server 112 may be coupled to each other via the signal relay 602 and the communication network 114. The host device 106 may be wirelessly coupled to the sensor devices 103 via the signal relay 602. The host device 106 may be further configured to receive the detection information from the sensor devices 103 by way of the signal relay 602.

As shown in FIG. 6, the UIDs and data from the sensor devices 103 embedded in the wearables 102 can be transmitted to the application server 110 via the signal relay 602, the host device 106, and the communications network 114. The application server 110 can match the UIDs of the wearables 102 to the associated host device 106 and determine whether a water submersion event is occurring, and the application server 110 can transmit the data from the sensor devices 103 and/or notifications relating to a water submersion event to the associated host device 106 via the communication network 114. According to some aspects of the present disclosure, the host device can process the data from the sensor devices 103 and determine whether a water submersion event is occurring and can transmit same to the application server 110 via the communication network 114. Furthermore, the application server 110 can match the UIDs of the wearables 102 to one or more associated guest devices 108 and the application server 110 can transmit the data from the sensor devices 103 and/or notifications relating to a water submersion event to the associated guest devices 108 via the communication network 114. Accordingly, the host device 106 receives data and/or notifications relating to a water submersion event from all of the wearables 102 of system 600, either directly or via application server 110, and the application server 110 transmits data and/or notifications relating to a water submersion event from the wearables 102 of system 600 only to guest devices 108 associated therewith via the communication network 114.

Notably, system 600 differs from system 100 in that the one or more wearables 102 are not in direct communication with the host device 106 but are in communication with the host device 106 indirectly via the signal relay 602. The signal relay(s) 602 may include suitable logic, circuitry, interfaces, and/or code, executable by one or more processors, which may be configured to transmit the detection information of the sensor devices 103 directly to the host device 106. The signal relay 602 may be configured to act as a relay between the host device 106 and the sensor devices 103 to extend the communication range of the sensor devices 103 or to increase the number of wearables 102 that can be connected to the host device 106. The signal relay 602 may be located, for example, adjacent to or floating on the body of water. The signal relay 602 may be configured to provide low-power, e.g., short range connection to the sensor devices 103 and may transmit the detection information of the sensor devices 103 directly to the host device 106. The signal relay 602 may be a computing device or a communication device, such as, Wi-Fi router, a smartphone, a laptop, a Bluetooth range extender, a Wi-Fi range extender, or the like. As previously discussed, the signal relay(s) 602 may further include a dual-band transceiver configured to communicate over multiple wireless protocols including protocols suitable for underwater signal transmission and above-water signal transmission. In some examples the dual-band transceiver may be two transceivers and two antenna types, with one antenna below the surface of the water configured for underwater communication, and a second antenna above the surface of the water configured for above-water communication. In still other examples, the underwater communication antenna and transceiver may be above the surface of the water, but within a suitable range of the wearable 102 to ensure reliable connection with a submerged wearable 102.

The network topology of system 600 is advantageous where the host device 106 is outside of communications range with the wearables 102 or may not be within communications range of the wearables 102 on a continuous basis. Accordingly, by communicating indirectly via the signal relay 602, the host device 106 can continue to monitor the wearables 102 without needing to be within direct communications range of the wearables. According to one exemplary embodiment, the wearables 102 can be connected to the signal relay 602 via a Bluetooth or low-power Wi-Fi connection and the host device 106 can be a mobile telecommunications device (e.g., an iPhone) connected to the signal relay via a second Bluetooth connection or via a direct Wi-Fi connection, thereby allowing the host device 106 to travel beyond the normal communications range defined by the wireless protocol utilized by the wearables 102 (e.g., Bluetooth or low-power Wi-Fi). Those of ordinary skill in the art will understand that numerous communication protocols and technologies can be utilized to establish connections between the wearables 102, the host device 106, the guest devices 108, and the signal relay 602 with the communication network 114 according to the network topology shown and described in connection with FIG. 6, without departing from the spirit and scope of the present disclosure.

FIG. 7 illustrates a system environment 700 for preventive water submersion detection, according to yet another aspect of the present disclosure. System 700 is substantially similar to system 600, but for distinctions noted herein. Accordingly, similar reference numerals of system 700 indicate similar hardware and software components as those of system 600, shown and described in connection with FIG. 6. As shown in FIG. 7, the system environment 700 includes the wearables 102, the host device 106, the guest devices 108, the signal relay 602, the application server 110, and the database server 112. The signal relay 602, the host device 106, the guest devices 108, the application server 110, and the database server 112 may be coupled to each other via the communication network 114.

The sensor devices 103 are wirelessly coupled to the signal relay 602 and the signal relay is wirelessly coupled to the communication network 114. The host device 106 may be wirelessly coupled to the sensor devices 103 via the signal relay 602 and the communication network 114. The host device 106 may receive the detection information from the sensor devices 103 by way of the signal relay 602, the application server 110, and the communication network 114. The guest devices 108 may be wirelessly coupled to the sensor devices 103 via the signal relay 602 and the communication network 114.

As shown in FIG. 7, the UIDs and data from the sensor devices 103 embedded in the wearables 102 can be transmitted to the application server 110 via the signal relay 602 and the communications network 114. The application server 110 can match the UIDs of the wearables 102 to the associated host device 106 and determine whether a water submersion event is occurring, and the application server 110 can transmit the data from the sensor devices 103 and/or notifications relating to a water submersion event to the associated host device 106 via the communication network 114. Furthermore, the application server 110 can match the UIDs of the wearables 102 to one or more associated guest devices 108 and the application server 110 can transmit the data from the sensor devices 103 and/or notifications relating to a water submersion event to the associated guest devices 108 via the communication network 114. Accordingly, the host device 106 receives data and/or notifications relating to a water submersion event from all of the wearables 102 of system 700 via the application server 110, and the application server 110 transmits data and/or notifications relating to a water submersion event from the wearables 102 of system 700 only to guest devices 108 associated therewith via the communication network 114.

Notably, system 700 differs from system 600 in that the host device 106 is not in direct communication with the signal relay 602 and, as such, the host device does not receive the detection information of the sensor devices 103 directly via the signal relay 602. Instead, as shown in FIG. 7, the host device 106 communicates indirectly with the sensor devices 103 of the wearables 102 via the signal relay 602, the communication network 114 and the application server 110. The signal relay 602 may include suitable logic, circuitry, interfaces, and/or code, executable by one or more processors, which may be configured to transmit the detection information of the sensor devices 103 to the application server 110 via the communication network 114. The signal relay 602 may be configured to act as a relay between the sensor devices 103 and the communication network 114 to extend the communication range of the sensor devices 103 and/or to increase the number of wearables 102 that can be connected to the communication network 114. The signal relay 602 may be located, for example, adjacent to the body of water or floating on the surface of the water. The signal relay 602 may be configured to provide low-power, e.g., short range connection to the sensor devices 103 and may transmit the detection information of the sensor devices 103 to the application server 110 via the communication network 114. The signal relay 602 may be further configured to provide high-power, e.g., long range connection to the communication network 114. The signal relay 602 may be a computing device or a communication device, such as, Wi-Fi router, a smartphone, a laptop, a Bluetooth range extender, a Wi-Fi range extender, or the like. As previously discussed, the signal relay(s) 602 may further include a dual-band transceiver configured to communicate over multiple wireless protocols including protocols suitable for underwater signal transmission and above-water signal transmission. In some examples the dual-band transceiver may be two transceivers and two antenna types, with one antenna below the surface of the water configured for underwater communication, and a second antenna above the surface of the water configured for above-water communication. In still other examples, the underwater communication antenna and transceiver may be above the surface of the water, but within a suitable range of the wearable 102 to ensure reliable connection with a submerged wearable 102.

The network topology of system 700 is advantageous where the host device 106 is outside of communications range with the wearables 102 or may not be within communications range of the wearables 102 on a continuous basis. Accordingly, by communicating indirectly via the signal relay 602, the host device 106 can continue to monitor the wearables 102 without needing to be within direct communications range of the wearables. According to one exemplary embodiment, the wearables 102 can be connected to the signal relay 602 via a Bluetooth or low-power Wi-Fi connection, and the signal relay 602 can be connected to the communications network 114 via high-power long-range Wi-Fi connection, such as, for example, Wi-Fi 6 (or IEEE 802.11ax) operating in the 2.4 GHZ, 5 GHZ, and/or 6 GHz bands. The present disclosure contemplates additional wireless communication protocols and standards, including those in development or developed at a future point. According to some embodiments, the and the signal relay 602 can be connected to the communications network 114 via a hard-wired network connection (e.g., an CAT6 ethernet connection to a LAN). Accordingly, the wearables 102 can utilize a low-power communication protocol to minimize energy consumption, preserve battery life, and extend operation time, while also being able to connect to the communication network 114 and the other devices of system 700 over larger distances than would otherwise be possible with conventional low-power communication protocols. Additionally, the host device 106 can travel beyond the normal communications range defined by the low-power wireless protocol utilized by the wearables 102 (e.g., Bluetooth or low-power Wi-Fi). Those of ordinary skill in the art will understand that numerous communication protocols and technologies can be utilized to establish connections between the wearables 102, the host device 106, the guest devices 108, and the signal relay 602 with the communication network 114 according to the network topology shown and described in connection with FIG. 7, without departing from the spirit and scope of the present disclosure.

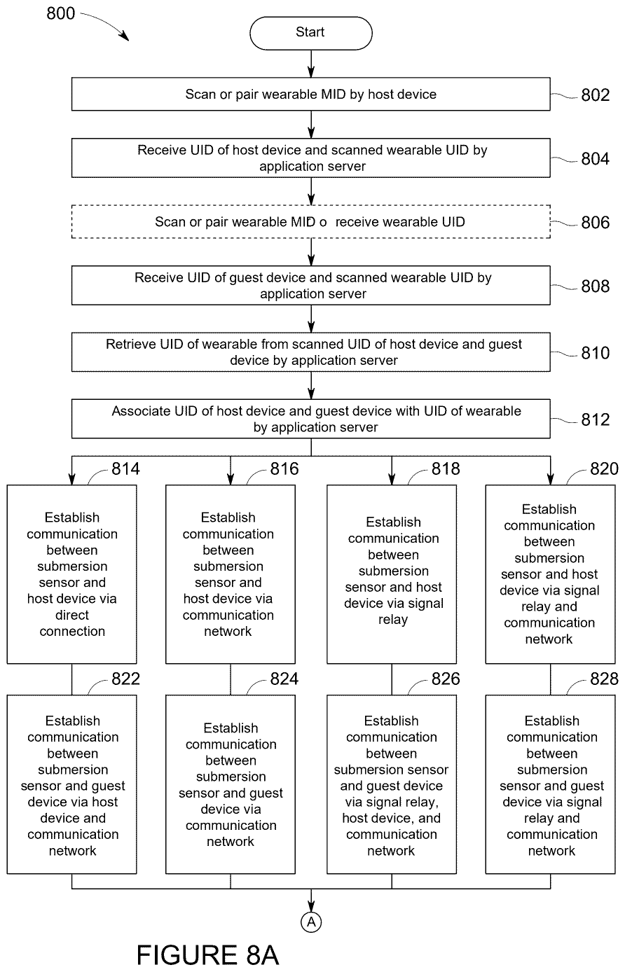

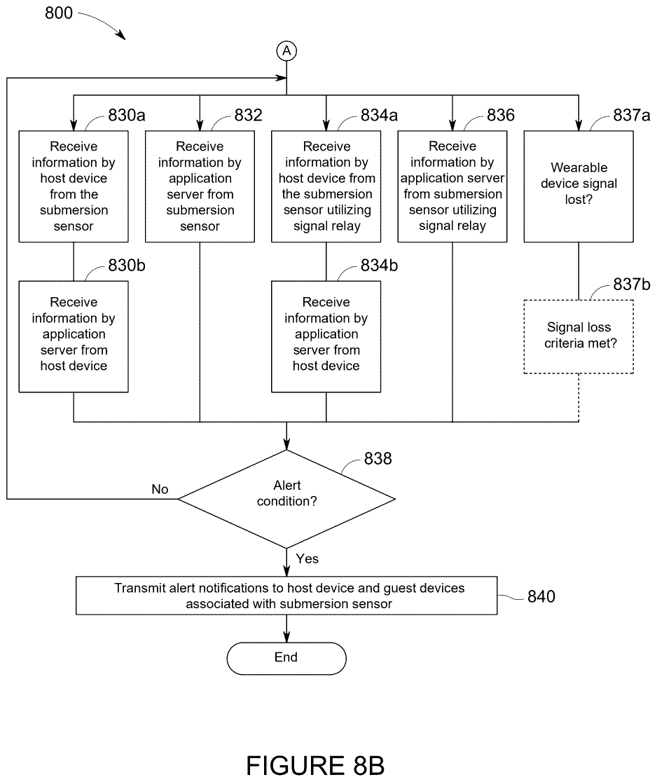

FIGS. 8A and 8B illustrate a flow chart 800 representing a method for preventive water submersion detection, in accordance with an exemplary embodiment of the disclosure.

At 802, the host device 106 scans the wearable MID, or other computer-readable means of identification described herein, embedded on a wearable 102 to associate the host device 106 with the MID of the wearable 102. The MID on the wearable 102 may include the unique identification number (UID) assigned to the wearable 102. At 804, the application server 110 receives the UID of the host device 106 and the scanned wearable UID from the host device 106, for example, via an application running on the host device 106 or at a remote location (e.g., a cloud server, a network-attached server, and the like). The host device 106 can also be designated as a host device via the application.

At 806, if guest device(s) 108 are optionally provided, one or more guest devices 108 scan the MID embedded on the wearable 102 or receive the wearable UID to associate the guest devices 108 with the UIDs of the wearables 102. At 808, the application server 110 receives the UID of the guest devices 108 and the scanned UIDs of the wearable 102 are received from the guest devices 108 or host device 106, for example, via an application running on the guest device 108. The guest device 108 can also be designated as a guest device via the application.

At 810, the application server 110 retrieves the UID of the host device 106 and, optionally, the UID of the guest devices 108. The MID engine 202a may be configured to retrieve the UID of the wearable 102 from the scanned MID of the wearable 102 received from the host device 106. Optionally, the MID engine 202a may be configured to retrieve the UID of the wearable 102 from the scanned MID of the wearable 102 received from the guest device 108. Further, the MID engine 202a may be configured to transmit the UID of the wearable 102 to the association engine 202b.

At 812, the application server 110 associates the UID of the host device 106 and optionally the UID of the guest devices 108 with the UID of the wearable 102. The association engine 202b may be configured to associate the UID of the host device 106 and the UID of the guest devices 108 with the UID of the wearable 102 and transmit the UID of the host device 106 and the UID of the guest devices 108 associated with the UID of the wearable 102 to the database server 112 via the communication network 114. Optionally, steps 802-812 can be repeated for a plurality of wearables 102, thereby associating each of the plurality of wearables 102 with one or more guest devices 108 and the single host device 106, allowing the host device 106 to monitor each of the plurality of (e.g., local) wearables and allowing a plurality of guest devices 108 to monitor a (e.g., local or remote) wearable 102 associated with a particular guest device 108. After 812, one of 814, 816, 818, and 820 is executed to establish communication between the host device 106 and the sensor device 103 of the wearable 102.

At 814, the application server 110 establishes communication between the host device 106 and the sensor device 103 via direct connection. At 816, the application server 110 establishes communication between the host device 106 and the sensor device 103 via the communication network 114. At 818, the application server 110 establishes communication between the host device 106 and the sensor device 103 via the signal relay 602. At 820, the application server 110 establishes communication between the host device 106 and the sensor device 103 via the signal relay 602 and the communication network 114.

After executing 814, 816, 818, and 820, one of 822, 824, 826, and 828 is executed, respectively, to establish communication between the guest devices 108 and the sensor devices 103. At 822, the application server 110 establishes communication between the guest devices 108 and the sensor device 103 via the host device 106 and the communication network 114. At 824, the application server 110 establishes communication between the guest devices 108 and the sensor device 103 via the communication network 114. At 826, the application server 110 establishes communication between the guest devices 108 and the sensor device 103 via the signal relay 602, the host device 106, and the communication network 114. At 828, the application server 110 establishes communication between the guest devices 108 and the sensor device 103 via the signal relay 602 and the communication network 114.

After executing 822, 824, 826, and 828, one of 830a and 830b, 832, 834a and 834b, 836, and 837a and optionally 837b is executed to receive the detection information or wearable device 102 signal information from the sensor device 103. At 830a, the host device 106 receives the detection information from the sensor device 103. At 830b, the application server 110 receives the detection information from the host device 106 via the communication network 114. At 832, the application server 110 receives the detection information directly from the sensor device 103 via the communication network 114.

At 834a, the host device 106 receives the detection information from the sensor device 103 via the signal relay 602. At 834b, the application server 110 receives the detection information from the host device 106 via the communication network 114. At 836, the application server 110 receives the detection information from the sensor device 103 directly via the signal relay 602 via the communication network 114. At 837a, the application server, signal relay, host device, and/or guest device determines if a communication link or signal from wearable 102 has been lost, degraded, or otherwise unrecognizable, as described herein. At 837a, optionally the characteristics of the communication link or signal from the wearable 102 is compared to one or more criteria to determine if signal has been lost, as described herein.

After executing 830a and 830b, 832, 834a and 834b, 836, and 837a and optionally 837b, then 838 is executed. At 838, the application server 110 determines whether the alert condition is detected. If at 838, the application server 110 determines that the alert condition is not detected, then one of 830a and 830b, 832, 834a and 834b, and 836 is executed again. If at 838, the application server 110 determines that the alert condition is detected, then 840 is executed.

At 840, the application server 110 sends the alert notifications to the host device 106 and the respective guest devices 108 associated with the wearable 102 to indicate that the user wearing the wearable 102 is experiencing a potential water submersion. Based on the association of the UID, the association engine 202b may be configured to send the alert notifications to the host device 106 and the guest devices 108 that are associated with the wearable 102.

The preventive water submersion detection system facilitates numerous advantages, including early detection of submersion, enhancing child safety by embedding sensors in everyday items like garments, jewelry, or accessories. The user-friendly machine-readable identifier (MID) and mobile alert app ensure quick setup and ease of use, while allowing multiple user devices to receive alerts, providing a robust safety net. This system offers peace of mind to parents and caregivers, is versatile and adaptable, and leverages modern technology for practical application. It promotes community safety by enabling shared responsibility and customizable alerts, serving as both a preventive measure and a life-saving tool in water hazard environments.

Below is a non-exhaustive summary of novel and non-obvious aspects of the present disclosure.

In one aspect, a preventive drowning-detection system includes a wearable device equipped with a machine-readable identifier containing a unique identifier, a communication module, and a submersion sensor configured to produce a signal indicative of at least partial submersion in a body of water. A host device includes a reader that acquires the wearable identifier and transmits the wearable and host identifiers to an application server. The application server retrieves the wearable identifier, associates it with the host identifier, and, when it receives a submersion signal exceeding a defined threshold, transmits an alert notification to the associated host device.

In another aspect, the wearable device periodically transmits a status signal at defined time intervals.

In another aspect, an alert is generated when the status signal is not received or when communication with the wearable device has been lost for a second predefined duration.

In another aspect, the status signal is provided as a ping transmitted at a predefined interval, and in another aspect the interval is variable.

In another aspect, the wearable device communicates with the host device and/or the application server.

In another aspect, the system includes one or more guest devices, each having a machine-readable identifier and a unique identifier, with each guest device configured to monitor detection data or status information generated by the wearable device.

In another aspect, when the submersion signal exceeds a threshold, the wearable device, host device, or application server generates an alert signal, and the host device may emit a visual, audio, or tactile alert.

In another aspect, the machine-readable identifier on the wearable may be implemented as a QR code, barcode, or near-field communication element.

In another aspect, the wearable device communicates directly with the host device, or through a communication network or a signal-relay device.

In another aspect, a signal-relay device receives the submersion signal from the wearable device and forwards that signal to one or more of the application server, host device, or guest device. The relay may also receive and forward status signals.

In another aspect, the relay device converts between different communication protocols, such as between an underwater transceiver and an above-water wireless transceiver. The relay may be positioned near the monitored water.

In another aspect, the wearable device is provided as a bracelet, clothing article, or diaper integrating the submersion sensor. The sensor may include a pressure sensor, conductive sensor, or capacitive sensor. Upon detection of a submersion event, the wearable device, host device, or application server may trigger visual, audio, or tactile alerts on each associated device.

In another aspect, a water-detection apparatus includes a housing adapted for attachment to a wearable article, a submersion sensor generating a submersion-correlated signal, a processor configured to identify when the signal exceeds a threshold or when the signal is absent for a specified duration, and a communication module that transmits an alert to a remote device. The processor may compute a duration of submersion exceeding a preset time before issuing the alert. The housing may also include a machine-readable identifier enabling association with host, guest, or server devices.

In another aspect, a preventive drowning-detection method includes scanning a machine-readable identifier of a wearable device to obtain its unique identifier; receiving both the wearable identifier and a host-device identifier at an application server; associating the identifiers; establishing communication between the wearable and host devices directly or through a relay; receiving detection data from a submersion sensor; determining that the data indicates submersion; and transmitting an alert notification to the associated host device. In another aspect, the detection data is transmitted through a relay positioned near the water.

In another aspect, one or more of the wearable device, the application server, and/or the host device compares the submersion signal to a first threshold.

In another aspect, the application server may be hosted locally on the host device or remotely.

In another aspect, the communication module of the wearable device, host device, or relay employs both short-range and long-range wireless communication protocols.

In another aspect, the association server stores identifier associations in a structured data table located either locally or on a remote database server.

In another aspect, a signal-relay device includes a first and second transceiver that operate using the same communication protocol.

In another aspect, a signal-relay device includes a first and second transceiver that operate using different communication protocols.

In another aspect, the signal-relay device is housed within a structure capable of floating on the surface of the water.

In another aspect, a method includes communication between the relay device and the host device using a first communication protocol, while the relay communicates with the wearable device using a second communication protocol. In another aspect, the first protocol may differ from the second protocol, and in another aspect the first protocol may be the same as the second protocol.

It is understood that the above description is intended to be illustrative, and not restrictive. It is intended to cover all alternatives, modifications and equivalents as may be included within the scope of the disclosure as defined in the appended claims. Many other embodiments will be apparent to those of skill in the art upon reviewing the above description. In the appended claims, the terms “including” is used as the plain-English equivalent of the respective term “comprising” respectively.

Techniques consistent with the disclosure provide, among other features, systems and apparatus for assisting people having limited upper limb strength, mobility, and control. While various exemplary embodiments of the disclosed systems and methods have been described above, it should be understood that they have been presented for purposes of example only, and not limitations. The subject matter presented herein is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Unless stated otherwise, terms such as “first” and “second” are used to arbitrarily distinguish between the elements such terms describe. Thus, these terms are not necessarily intended to indicate temporal or other prioritization of such elements.

Unless otherwise stated, conditional languages such as “can”, “could”, “will”, “might”, or “may” are understood within the context as used in general to convey that certain embodiments include, while other embodiments do not include, certain features, elements, and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It will be understood by those within the art that, in general, terms used herein, are generally intended as “open” terms e.g., the term “including” should be interpreted as “including but not limited to,” the term “having” should be interpreted as “having at least,” the term “includes” should be interpreted as “includes but is not limited to,” etc.

What is claimed is:

1. A preventive drowning detection system comprising:
a wearable device including a first machine-readable identifier (MID) including a wearable unique identifier (UID), a communication module, and a submersion sensor, the submersion sensor configured to generate a submersion signal indicative of at least partial submersion in a body of water;
a host device having MID reader configured to receiver the first wearable UID, the host device further configured to transmit a first host UID and the first wearable UID to an application server; and
the application server configured to:
(a) retrieve the first wearable UID;
(b) associate the first wearable UID with the first host UID; and
(c) transmit, upon receiving from the wearable device the first submersion signal exceeding a first threshold, an alert notification to the host device associated with the wearable device.

2. The system of claim 1, the wearable device configured to transmit a status signal at least once per first predetermined time interval.

3. The system of claim 2, wherein an alert notification is generated when a status signal has not been received or a communication link with the wearable device has been lost for at least a second predetermined time interval.

4. The system of claim 2, wherein the status signal is a ping transmitted at a predefined interval.

5. The system of claim 4, wherein the predefined interval is variable.

6. The system of claim 1, wherein the wearable device is configured to communicate with the host device and/or the application server.

7. The system of claim 1, further comprising one or more guest devices each having a respective guest device MID including a guest device UID, each guest device configured to monitor detection information or a status signal of the wearable device.

8. The system of claim 1, wherein, upon determining that the first submersion signal exceeds a first threshold, the wearable device, application server, and/or host device generates an alert signal based on the detection.

9. The system of claim 8, wherein, in response to the alert signal, the host device emits a visual, audio, or tactile submersion alert.

10. The system of claim 1, wherein the wearable MID is a quick-response (QR) code, barcode, or near-field communication device.

11. The system of claim 1, wherein the wearable device is first wearable device and is in direct communication with the host device.

12. The system of claim 1, wherein the wearable device is a first wearable device and is in communication with the host device and/or a guest device via a communication network or a signal relay device.

13. The system of claim 1, further comprising a signal relay device configured to receive the first submersion signal from the wearable device and transmit the submersion signal to one or more of the application server, host device, and/or guest device.

14. The system of claim 13, wherein the signal relay device is configured to receive the status signal and/or the submersion signal and transmit the status signal and/or the submersion signal to one or more of the application server, the host device, and the guest device.

15. The system of claim 13, wherein the signal relay device is further configured to convert between a first communication protocol and a second communication protocol.

16. The system of claim 15, wherein the first transceiver is configured to transmit and receive information under the surface of the body of water and the second transceiver is configured to transmit and receive information wirelessly above water.

17. The system of claim 16, wherein the signal relay device is positioned proximal to the body of water.

18. The system of claim 1, wherein the wearable device comprises a bracelet, clothing article, or diaper incorporating the submersion sensor.

19. The system of claim 1, wherein the submersion sensor comprises at least one of a pressure sensor, a conductive sensor, and/or a capacitive sensor.

20. The system of claim 1, wherein, upon detection of a submersion event, the host device, the wearable, and/or the application server causes an alert notification to emit a visual, audio, or tactile signal on each associated device.

21. A water-detection apparatus comprising:
a housing configured for attachment to a wearable article;
a submersion sensor configured to generate a submersion signal corresponding to submersion in water;
a processor configured to determine that the submersion signal exceeds a predefined threshold and/or the submersion signal has not been received after a predetermined period of time; and
a communication module configured to transmit an alert signal to a remote device upon determination of the submersion condition.

22. The apparatus of claim 21, wherein the processor is further configured to calculate a submersion duration exceeding a preset time before transmission of the alert signal.

23. The apparatus of claim 21, wherein the housing further comprises a machine-readable identifier (MID) for associating the apparatus to a host device, a guest device, and/or an application server.

24. A method for preventive drowning detection comprising:
scanning, by a host device, a wearable machine-readable identifier (MID) of a wearable device to determine a wearable unique identifier (UID);
receiving, at an application server, a host device UID and the wearable UID;
associating, by the application server, the UIDs of the wearable device with the host device;
establishing a communication link between the wearable device and the host device directly or through a signal relay;
receiving, by the application server, detection data from a submersion sensor coupled to the wearable device;
determining, by the application server, that the detection data indicates a submersion condition; and
based upon the detection of the submersion condition, transmitting, using the communication link, an alert notification to the host device associated with the wearable device.

25. The method of claim 24, further comprising transmitting the detection data from the wearable device to the host device or application server via a signal relay positioned proximal to a body of water.
